(19) United States
(12) Patent Application Publication
(10) Pub. No.: US 2006/0284763 A1
(43) Pub. Date: Dec. 21, 2006

(54) Cyber Tracker

(75) Inventor: Joshua Ian Riley, Arden, NC (US)

Correspondence Address: Ben D. Tobor;Bracewell & Giuliani LLP, P.O Box 61389, Houston, TX, 77208-1389, US

(73) Assignee: HOMELAND INTEGRATED SECURITY SYSTEMS, Arden, NC (US)

(21) Appl. No.: 10/906,248

(22) Filed: Feb. 10, 2005

(51) Int. Cl. G01C 21/00

(52) U.S. Cl. 342/357.07; 701/213

(57) ABSTRACT

The Cyber Tracker, a 5 inch square by 1 inch thick battery powered GPS device is placed in the entering vehicle or asset. A customized software application transmitted wirelessly imposes an icon specific to that vehicle on a computerized map in any number of on or off site locations. Administratively defined criteria (i.e. speed, location, stopping time and route designation to name a few) can be set so that a series of alarms can be triggered if the criteria are violated. “Geo fencing”, a unique characteristic of the Cyber Tracker, allows the administrator to define specific areas that can be determined as “off limits” and as such will trigger alarms if the assigned Cyber Tracker enters the defined space. The reverse can also be used by “fencing” a vehicle or asset inside a defined area. It is also capable of providing position reports at predetermined intervals ranging from minutes to hours. The alarming system can notify the individual monitoring the computer screen by an audible alarm or a variety of other short or long distance calls to any land line phone, cell phone or pager. Essentially, an alarm can be triggered and notification can be sent via any of a variety of means to anywhere on the globe. Remote monitoring from multiple locations simultaneously is also available. The Cyber Tracker wirelessly transmits its information and data over a variety of secured networks

The Cyber Tracker is a 5 inch square by 1 inch thick battery powered GPS device that is placed in the entering vehicle or asset. The Cyber Tracker utilizes a board that includes GPS, WiDen and Push To Talk. A customized software application transmitted wirelessly imposes an icon specific to that vehicle on a computerized map in any number of on or off site locations.

### IN THE SPECIFICATION

On page 1, Applicant adds a BRIEF DESCRIPTION OF THE DRAWINGS, to read as follows:

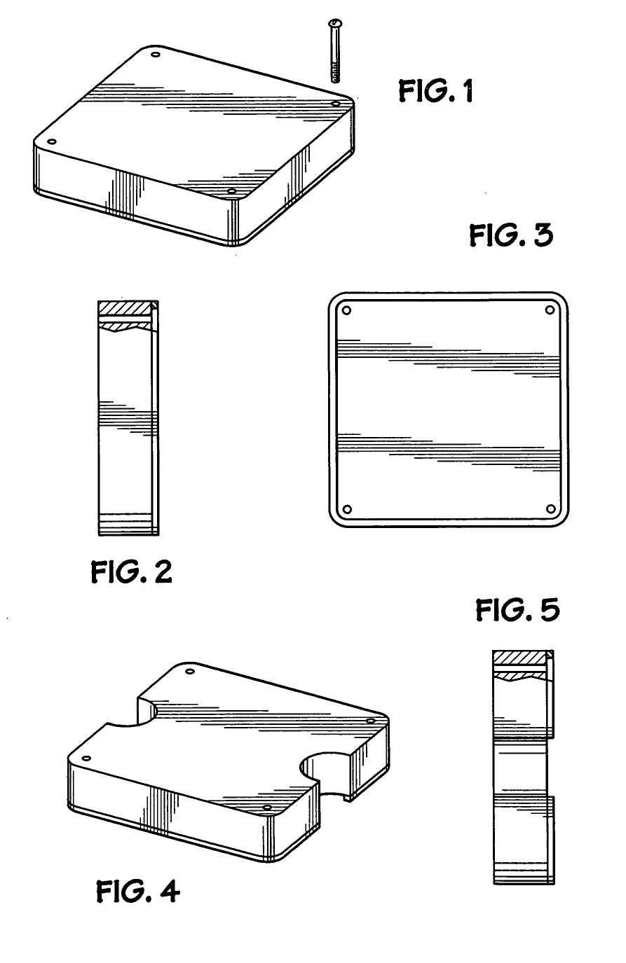

FIG. 1 is a perspective view of a tracking device according to an embodiment of the present invention.

FIG. 2 is a side view of a tracking device according to an embodiment of the present invention.

FIG. 3 is a bottom view of a tracking device according to an embodiment of the present invention.

FIG. 4 is a perspective view of a tracking device according to an embodiment of the present invention.

FIG. 5 is a side view of a tracking device according to an embodiment of the present invention.

What is claimed is:

1. Cyber Tracker Key Features
Speaker-microphone, enabling VoD
Embedded TCP/IP stack
Unique Charging System allowing multiple units to be charged at once
Over-the-Air (OTA) capabilities for remote firmware update/feature upgrades
The Cyber Tracker Supports WiDen a High speed data feature
Cyber Tracker Base Functionality:
Launcher software application
Encryption protocol layer (128-bit AES)
Ignition Sense and low voltage monitor (Option for Fixed Unit)
Rugged Design for 3+ Years of Normal Wear and Tear
Internal real-time clock
Sleep mode when the Cyber Tracker© is placed on the Charging Dock
Power on when the Cyber Tracker© is removed from the Charging Dock
GPS loop-back to user-defined server
Store, hold and forward for GPS and telemetry data
Speaker, Microphone, PTT Button allowing communication to Cyber Trackers
Operating Temperature −25C to +60C
Storage Temperature −40C to +85C
Operating Humidity 0 to 95% RH noncondensing at +50C.
